(19) United States
(12) Patent Application Publication
(10) Pub. No.: US 2015/0126213 A1
(43) Pub. Date: May 7, 2015

(54) System for Mapping an Indoor Space Using Wireless Network and Method

(71) Applicant: GFI Software IP S.a.r.l., Luxembourg (LU)

(72) Inventor: Samer Nabih Fayssal, Dunedin, FL (US)

(73) Assignee: GFI Software IP S.a.r.l., Luxembourg (LU)

(21) Appl. No.: 14/070,119

(22) Filed: Nov. 1, 2013

(51) Int. Cl. H04W 4/04

(52) U.S. Cl. CPC H04W 4/04
USPC 455/456.1

(57) ABSTRACT

The present invention provides a system and method for electronic indoor/outdoor mapping and localization. The system may include a map and a mapper to detect conditions of an indoor space. The disclosed system may utilize data collected from a location detecting device, such as a global positioning systems (GPS) sensor and/or an accelerometer, a network detecting device, a compass, and/or other sources. The other sources may include wireless providers, user live sketches, and/or WLAN monitors to create a best effort optimized indoor/outdoor map. The system may determine a position of walls, wireless networking devices, and other objects within the indoor space. A method is provided for mapping an indoor space.

### FIELD OF THE INVENTION

The present invention relates to mapping an indoor space. More specifically, the present invention relates to mapping an indoor space using a wireless network.

### BACKGROUND

A wireless local area network (WLAN) is established using a wireless networking device, such as a wireless router or wireless switch. The wireless networking device mostly provides local area network access to wirelessly connected client devices, such as client stations. Client stations include notebook/laptop computers, smartphones, tablets, and other portable computer network devices. Wireless networking devices and client stations can both be wireless devices.

A received signal strength indication (RSSI) is a measurement for signal power that is sensed at the receiver side. A WLAN communication between two devices is established if the two devices can receive the communication messages with a minimum threshold. These messages are known as frames. The threshold is determined by examining the error rate between the communicating parties. This minimum threshold is used to estimate a maximum allowed distance between the communicating devices. Distance estimation using current practices is mostly inaccurate due to many signal loss factors. Loss factors can reduce signal power, and thus affect compliance with the minimum threshold. This factor often misleads the distance calculations performed respective to the RSSI. According to standard open-space distance calculations, most wireless receivers can provide a radius of at least thirty meters. However, in the present state of the art, this estimation is mostly inaccurate for indoor devices due to the lack of accurate signal loss estimations.

WLAN communication between two devices requires that both devices transmit and receive frames on the same channel. A channel is an air frequency at which data is communicated. A WLAN functions within a pre-assigned range of frequencies. Each WLAN frame is defined within a standard known as IEEE 802.11. A WLAN radio is a hardware transceiver that sends and receives signals on one channel at a time. Received signals are quantified in time samples known as bits. A frame is a group of logically organized bits. If a bit is lost in the communication channels, it may corrupt a frame construction. The larger the distance between the transmitter and receiver, the more those signals are subject to fading, getting lost, or being replicated. For indoor communication of frames, larger distances generally include a large number of separators (e.g., walls) separating the communicating devices. The higher the frequency, the more susceptible the signal is to attenuation due to failure to penetrate a wall. Using lower frequencies can increase signal travel distance, however data communication bandwidth may be limited.

Electronic maps are currently used in global positioning systems, internet live mapping and direction systems, localization of homes or businesses on a map, weather mapping, and more. Electronic indoor mapping techniques are currently rigid and depend on traditional indoor sketches generated by hand. For example, a typical indoor map requires a user created sketch to be uploaded into a system to identify specific stationary objects such as walls, corners, windows, doors, and floors.

Current online maps lack application to indoor spaces, since these maps mostly consider outdoor locations labeled according to user preferences. Additionally, current maps typically have limited elevation details. While some maps include 3D views, such views generally lack accuracy and sufficient descriptions. Indoor details are rarely considered by any map due to the lack of proper indoor reporting resources. Even if some systems do include the capability to integrate indoor live user sketches, those sketches are generally inaccurate due to a lack of precision in determining wall positioning. Such inaccuracies can also be due to inability to properly translate user sketches uploaded from physical media, such as paper.

What is needed is a system that permits users to electronically define an area of an indoor space. What is needed is an indoor mapping system that can accurately define walls and objects in the indoor space. What is needed is an indoor mapping system to define wall positions and directions. What is needed is an indoor mapping system to enhance location accuracy by integrating a location detecting device and a network detecting device. What is needed is an ability to identify an indoor space with respect to area, elevation, and a wireless network signal. What is needed is a system to associate an indoor space with a profile storable in a database over a network, wherein a wireless network signal is associable with the profile. What is needed is a method to electronically map an indoor space using the system of the present invention.

### SUMMARY

The present invention advantageously provides a system that permits users to electronically define an area of an indoor space. Additionally, the system of the present invention advantageously provides an indoor mapping system that can accurately define walls and objects in the indoor space. The present invention advantageously provides an indoor mapping system to define wall positions and directions. The system of the present invention also advantageously provides an indoor mapping system to enhance location accuracy by integrating a location detecting device and a network detecting device. Moreover, the system of the present invention advantageously provides an ability to identify an indoor space with respect to area, position, elevation, and a wireless network signal. The system of the present invention may advantageously associate an indoor space with a profile storable in a database over a network, wherein a wireless network signal is associable with the profile. Furthermore, the present invention provides a method to electronically map an indoor space using the system of the present invention.

The present invention provides a system and method for substantially complete electronic indoor/outdoor mapping and localization. The disclosed system may utilize data collected from a location detecting device, such as a global positioning systems (GPS) sensor and/or an accelerometer, a network detecting device, a compass, and/or other sources. The other sources may include wireless providers, user live sketches, and/or WLAN monitors to create a best effort optimized indoor/outdoor map. The indoor map may include climate information, light information, air pressure, magnetic field, sounds, images, and other sensory information that would be apparent to a skilled artisan.

The system may include a geographic z-index that estimates the elevation including details relating to building floors. In addition, the system may enhance original outdoor map labels by adding local labels for different rooms within an indoor map. The system may use a digital compass to identify indoor wall positions. Identification of wall positions may help automatically generate local building/room borders that can be sketched by the system and/or users. Localizing indoor walls can help accurately estimate wireless communication signal fading. Collected wireless data can also help correct signal to distance errors.

The disclosed system may use WLAN mesh networks as reference points to improve indoor signal loss estimations. Measured wireless signal loss may be caused by walls, floors, static objects, moving objects, and other sources of interference. Upon accurate loss identification and mapping of wall positions, the present invention may track moveable objects according to signal interruptions between two or more WLAN devices. The system of the present invention can be used to create a useful and informative map of an indoor space that can be integrated with virtually any system on the over the network, for example, the internet.

Communication systems can use the system of the present invention to estimate signal to noise ratios and other network communication metrics of an indoor space. Additionally, users such as wireless security companies can use the present invention to estimate WLAN signals flowing beyond external building walls. In addition, millions of businesses around the globe can enhance their services by integrating this invention in their online services.

According to an embodiment of the present invention, an indoor mapping system is provided including a map and a mapper. The map may define an indoor space including an area substantially defined by a wall. The mapper may be positionable at a point within the indoor space to determine boundaries for the map and a characteristic of a wireless network signal communicable in the indoor space. The mapper may include a compass, a location detecting device, an elevation detecting device, and a network detecting device. The compass may identify an orientation of the wall. The location detecting device may determine a location of the wall. The elevation detecting device may determine an elevation. The network detecting device may determine the characteristic of the wireless network signal communicated in the indoor space, the characteristic including a received signal strength indication (RSSI) of the wireless network signal communicated from a wireless networking device. The map may be substantially automatically determined by the mapper being oriented at different points within the indoor space. The mapper may be movable about the wall to determine a shape of the wall. The map may be indicative of the elevation. The map may be associable with a profile storable on a database accessible over a network. The wireless network signal may be associable with the profile. A movable object may be detectable within the indoor space by analyzing an interference with the wireless network signal for a temporary duration, the movable object being definable in the profile.

In another aspect, the wall may include a border wall and an interior wall. The border wall may substantially enclose the indoor space and be detectable by the mapper to define at least part of the indoor space. The interior wall may be located substantially within the indoor space. The mapper may be located at the different points within the indoor space to provide data points relating to the interior wall to be analyzed for approximately determining a dimension and thickness of the interior wall. The data points may relate to the RSSI of the wireless network signal located within the indoor space respective to the interior wall to determine a loss factor.

In another aspect, the location of the wall is determinable by analyzing the loss factor at the different points about the wall with respect to the RSSI detected at each of the different points.

In another aspect, determining the location of the wall includes analyzing a distance of the mapper from the wireless networking device, the loss factor experienced by the mapper to the wireless network signal communicated with the wireless networking device, and a trajectory of the wireless network signal communicated with the mapper.

In another aspect, the thickness is approximated by analyzing attenuation of the wireless network signal caused by the interior wall.

In another aspect, the RSSI is analyzed to estimate signal fading caused by the interior wall, and wherein a client station is configurable to connect to the wireless networking device with low incidence of the signal fading.

In another aspect, the system may include an interface, the map being viewable via the interface.

In another aspect, the map may be viewable via the interface in approximately real-time

In another aspect, the location detecting device may include a GPS sensor.

In another aspect, the location detecting device may include an accelerometer.

In another aspect, the wireless networking device is locatable via triangulation using the wireless network signal detected by the mapper.

In another aspect, the map further includes tagged points of interest in the indoor space definable by a user.

In another aspect, a neighboring wireless signal is detectable and the wireless network signal is adaptable respective to the neighboring wireless signal.

According to an embodiment of the present invention, an indoor mapping system is provided having a map and a mapper. The map may define an indoor space including an area substantially defined by a wall. The wall may include one or more border walls and one or more interior wall. The border wall may substantially enclose the indoor space. The interior wall may be located substantially within the indoor space. The mapper may be positionable at a point within the indoor space to determine boundaries for the map and a characteristic of a wireless network signal communicable in the indoor space. The mapper may include a location detecting device and a network detecting device. The location detecting device may determine a location of the wall. The network detecting device may determine the characteristic of the wireless network signal communicated in the indoor space, the characteristic including a received signal strength indication (RSSI) of the wireless network signal communicated from a wireless networking device. The border wall is detectable by the mapper to define at least part of the indoor space. The map may be substantially automatically determined by the mapper being oriented at different points within the indoor space. The mapper may be movable about the wall to determine a shape of the wall. The mapper may be located at the different points within the indoor space to provide data points relating to the interior wall to be analyzed for approximately determining a dimension and thickness of the interior wall. The data points may relate to the RSSI of the wireless network signal located within the indoor space respective to the interior wall to determine a loss factor. The map may be associable with a profile storable on a database accessible over a network. The wireless network signal may be associable with the profile. A movable object may be detectable within the indoor space by analyzing an interference with the wireless network signal for a temporary duration, the moveable object being definable in the profile.

In another aspect, the mapper may include a compass to identify an orientation of the wall.

In another aspect, the mapper may include an elevation detection device to determine an elevation, and wherein the map is indicative of the elevation.

In another aspect, the thickness may be approximated by analyzing attenuation of the wireless network signal caused by the interior wall.

In another aspect, the RSSI may be analyzed to estimate signal fading caused by the interior wall, and wherein a client station is configurable to connect to the wireless networking device with low incidence of the signal fading.

In another aspect, the system may include an interface, the map being viewable via the interface.

In another aspect, the map may be viewable via the interface in approximately real-time.

In another aspect, wherein the location detecting device may include a GPS sensor.

In another aspect, the location detecting device may include an accelerometer.

In another aspect, the wireless networking device may be locatable via triangulation using the wireless network signal detected by the mapper.

In another aspect, the map may include tagged points of interest in the indoor space definable by a user.

In another aspect, a neighboring wireless signal may be detectable and the wireless network signal is adaptable respective to the neighboring wireless signal.

According to an embodiment of the present invention, a method aspect is provided for mapping an indoor space. The method may include (a) positioning a mapper at a point within the indoor space to determine boundaries for a map and a characteristic of a wireless network signal communicable in the indoor space, the map defining the indoor space including an area substantially defined by a wall. Determining the boundaries may further include (i) operating a compass of the mapper to identify an orientation of the wall, (ii) operating a location detecting device of the mapper to determine a location of the wall, (iii) operating an elevation detecting device to determine an elevation of the wall, and (iv) operating a network detecting device to determine the characteristic of the wireless network signal communicated in the indoor space, the characteristic including a received signal strength indication (RSSI) of the wireless network signal communicated from a wireless networking device. Additionally, the method may include (b) determining the map substantially automatically by the mapper being oriented at different points within the indoor space. The method may also include (c) associating the map with a profile storable on a database accessible over a network, the wireless network signal being associable with the profile. Moreover, the method may include (d) detecting a movable object within the indoor space by analyzing an interference with the wireless network signal for a temporary duration, the movable object being definable in the profile. The mapper may be movable about the wall to determine a shape of the wall. The map may be indicative of the elevation. The wireless network signal may be associable with the profile.

In another aspect of the method, the wall may include a border wall and an interior wall. The border wall may substantially enclose the indoor space and be detectable by the mapper to define at least part of the indoor space. The interior wall may be located substantially within the indoor space. The mapper may be located at the different points within the indoor space to provide data points relating to the interior wall to be analyzed for approximately determining a dimension and thickness of the interior wall. The data points may relate to the RSSI of the wireless network signal located within the indoor space respective to the interior wall to determine a loss factor.

In another aspect, the method may include (e) analyzing the loss factor at the different points about the wall with respect to the RSSI detected at each of the different points to determine the location of the wall.

In another aspect of the method, step (e) further involves analyzing a distance of the mapper from the wireless networking device, the loss factor experienced by the mapper to the wireless network signal communicated with the wireless networking device, and a trajectory of the wireless network signal communicated with the mapper.

In another aspect, the method further includes (f) analyzing attenuation of the wireless network signal caused by the interior wall to approximate the thickness of the interior wall.

In another aspect, the method further includes (g) analyzing the RSSI to estimate signal fading caused by the interior wall, wherein a client station is configurable to connect to the wireless networking device with low incidence of the signal fading.

In another aspect of the method, the map is viewable via an interface.

In another aspect of the method, the map is viewable via the interface in approximately real-time.

In another aspect of the method, the location detecting device may include a GPS sensor.

In another aspect of the method, the location detecting device may include an accelerometer.

In another aspect of the method, the wireless networking device may be locatable via triangulation using the wireless network signal detected by the mapper.

In another aspect of the method, the map may include tagged points of interest in the indoor space definable by a user.

In another aspect of the method, a neighboring wireless signal may be detectable, the method further including (h) adapting the wireless network signal respective to the neighboring wireless signal.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIGS. 1-3 are diagrams of an illustrative indoor space, according to an embodiment of the present invention.

FIG. 4 is a flow chart illustrating a mapping operation, according to an embodiment of the present invention.

FIG. 5 is a flow chart illustrating analysis of a wireless network signal within an indoor space, according to an embodiment of the present invention.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The invention provides a system and method for mapping an indoor and/or outdoor space. The system may include a map of an indoor space and a mapper usable to at least partially generate the map. The mapper may be located at different points within the indoor space to determine a location of walls, ceilings, floors, and other objects in the indoor space. The mapper may be moved around in the indoor space to generate multiple data points that can be analyzed to substantially automatically generate the map. Multiple mappers may also be used. The mapper may also detect and communicate with one or more wireless networking device and analyze one or more wireless network signal to determine conditions of the indoor space.

One or more of the analyses and/or calculations may be performed using a computerized device. An illustrative computerized device will now be discussed in greater detail, without limitation. The computerized device may include a processor, memory, network controller, and optionally an input/output (I/O) controller. Skilled artisans will appreciate additional embodiments of a computerized device that may omit one or more of the aforementioned components or include additional components without limitation. The processor may receive and analyze data. The memory may store data, which may be used by the processor to perform the analysis. The memory may also receive data indicative of results from the analysis of data by the processor.

The memory may include volatile memory modules, such as random access memory (RAM), or non-volatile memory modules, such as flash based memory. Skilled artisans will appreciate the memory to additionally include storage devices, such as, for example, mechanical hard drives, solid state data, and removable storage devices.

The computerized device may also include a network controller, which may be a wireless network interface controller. The network controller may receive data from other components of the computerized device to be communicated with other computerized devices via a network. The communication of data may be performed wirelessly. More specifically, without limitation, the network controller may communicate and relay information from one or more components of the computerized device, or other devices and/or components connected to the computerized device, to additional connected devices. Connected devices are intended to include data servers, additional computerized device, mobile computing devices, smart phones, tablet computers, and other electronic devices that may communicate digitally with another device.

The computer may also include an I/O interface. The I/O interface may be used to transmit data between the computerized device and extended devices. Examples of extended devices may include, but should not be limited to, a display, external storage device, human interface device, printer, sound controller, or other components that would be apparent to a person of skill in the art. Additionally, one or more of the components of the computerized device may be communicatively connected to the other components via the I/O interface.

The components of the computerized device may interact with one another via a bus. Those of skill in the art will appreciate various forms of a bus that may be used to transmit data between one or more components of an electronic device, which are intended to be included within the scope of this disclosure.

The computerized device may communicate with one or more connected devices via a network. The computerized device may communicate over the network by using its network controller. More specifically, the network controller of the computerized device may communicate with the network controllers of the connected devices. The network may be, for example, the internet. As another example, the network may be a WLAN. However, skilled artisans will appreciate additional networks to be included within the scope of this disclosure, such as intranets, local area networks, wide area networks, peer-to-peer networks, and various other network formats. Additionally, the computerized device and/or connected devices may communicate over a network via a wired, wireless, or other connection, without limitation.

Additionally, the system may detect and analyze one or more wireless network signals to map the indoor space. Wireless network signals may be generated by one or more wireless networking devices. Wireless networking devices are discussed throughout this disclosure in the context of a wireless router, but may also include any device capable of communicating over a wireless network. Client stations may also communicate over a network and may include desktop computers, notebook/laptop computers, printers, smartphones, network attached storage (NAS) devices, tablets, music players, televisions, audiovisual equipment, other electronic devices, and other devices that would be apparent to a person of skill in the art. Skilled artisans will appreciate that wireless networking devices may include at least one wireless network interface controller.

The system may detect and analyze network traffic, or data transmitted over one or more networks. The network traffic may be communicated between devices using network interface controllers. Skilled artisans will appreciate that the term wireless network interface controller, wireless networking interface controller, wireless networking card, network adapter, LAN adapter, and other similar terms may be used interchangeably, without limitation. A network interface controller is a computer hardware component that allows communication of a computerized device over a network. The network interface controller may receive data from various components of a computerized device, which it may then relay over a network. Similarly, the network interface controller may receive data from a network connection, which it may then relay to various components of the computerized device. A network interface controller may operate over a physically connected local area network (LAN) or wirelessly over a wireless local area network (WLAN).

A wireless network interface controller operates similarly to that of a traditional network interface controller, with the additional capability to communicate data wirelessly. Generally, a wireless network interface controller will include one or more radio transceivers, which may broadcast and receive radio signals over the air. A wireless network interface controller may communicate data with other devices using one or more data transmission protocols, for example, but not limited to, IEEE 802.11 Wi-Fi, token ring networks, Bluetooth, or other network protocols that would be apparent to a person of skill in the art. In the interest of clarity, the present invention will be discussed in the context of the IEEE 802.11 protocols without limitation.

As will be apparent to those of skill in the art, IEEE 802.11 defines various frequency ranges at which data may be transmitted, which are segmented into channels. Various devices may communicate different packets of data using a single channel. Additionally, some channels defined by the IEEE 802.11 specification overlap with other channels.

Throughout this disclosure, communication of data is discussed as occurring over a wireless network. A wireless network is any type of connection between two or more electronic devices to communicate data or information without being physically attached by wires or cables. For example, a wireless network may be a wireless local area network (WLAN). A WLAN is typically a wireless network established to provide communication between two or more wireless devices within a moderately short distance from a managing device, such as a wireless networking device. As discussed above, a WLAN may be compliant with a standard such as IEEE 802.11, communicate using a proprietary standard, and/or use another protocol that would be apparent to a skilled artisan. The WLAN may communicate with one or more wired device through use of a wireless bridge, as may be provided by a wireless router. For example, a client station may wirelessly communicate with the wireless router, which may then relay the communication to a wired electronic device via a cable, such as an Ethernet cable.

To communicate data between a transmitting wireless device and a receiving wireless device, the communication must generally be made over the same channel. A wireless network interface controller may receive virtually every bit communicated over a given channel, assuming the transmitting device is within range of the receiving device, including data intended for different wireless devices.

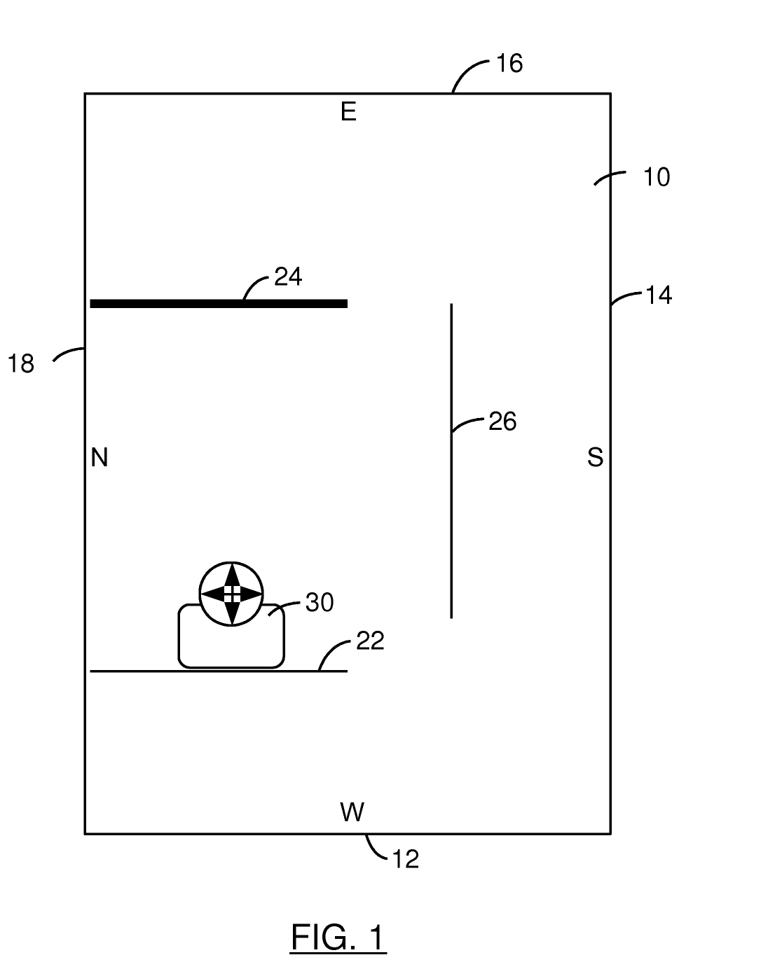

The components of the indoor mapping system will now be discussed in greater detail along with FIGS. 1-3. The indoor mapping system may include a map and a mapper. The mapper may be used to generate data points, which may be analyzed by the system to substantially automatically produce the map.

The map will now be discussed in greater detail. The map may provide a representation of an indoor space, or a space in the interior of a building. The indoor space may include an area defined by walls. For example, the space may be an interior floor space that is substantially bounded by the inward facing surfaces of border walls. The border walls may approximately define the perimeter of the indoor space, separating the indoor space from an outdoor exterior space. The indoor space may also include an elevation data point, which may indicate an elevation of the indoor space. For example, the elevation may indicate a floor level of the interior space located in a building with multiple floors.

The map may also include interior walls. An interior wall is a wall located within the indoor space substantially encircled by the border walls. An interior wall may define a work space, such as a room, cubicle, and/or other area. Interior walls may be located at various positions within the indoor space, and may be constructed using various materials. As a result, the interior walls may have varying effects on a wireless network signal communicated within the interior space. The indoor map may also include climate information, light information, air pressure, magnetic field, sounds, images, and other sensory information that would be apparent to a skilled artisan. Additionally, walls, floors, static objects, moving objects, and may also have varying effects on the wireless network signal.

The mapper will now be discussed in greater detail. The mapper may include a compass, a location detecting device, an elevation detecting device, a network detecting device, and/or additional detection devices to analyze a condition of the indoor space. The compass may be used to identify an orientation of a wall. For example, when the mapper is positioned adjacent to a wall, the compass may detect an orientation of the mapper. The wall orientation maybe analyzed to determine a direction that the wall is facing. Multiple readings of orientation information may be compared to determine the direction in which multiple walls and/or surfaces may face within an indoor space.

The mapper may also include a location detecting device to determine a location of one or more wall. The location detecting device may include a sensor to determine a geographic location of the wall. For example, the location detecting device may include a GPS sensor to determine a precise location of a wall. The mapper may determine the location of a first and opposing second side of the wall, which may be analyzed to calculate a length of the wall. Alternatively, multiple mappers may be included on the wall at different points to record multiple data points, each of which may be analyzed to determine a characteristic of the wall.

In an additional embodiment, the mapper may include an accelerometer to sense a distance the mapper is moved about a wall and/or the indoor space. For example, the mapper may be located at a first end of an interior wall. The mapper may then be moved across the length of the wall. The accelerometer may detect the distance moved across a horizontal axis, which may be analyzed to determine a length of the wall. Movement of the mapper about the wall may also be used to determine a shape of the wall.

An elevation detecting device may also be included by the mapper. The elevation detecting device may determine an elevation of the mapper, and thus the indoor space in which the mapper is operated. The mapper may determine the elevation via GPS, an altimeter, or another elevation detection technique that would be apparent after having had the benefit of this disclosure. The map may be substantially automatically determined from one or more mapper being oriented at different points within the indoor space.

The mapper may additionally include a network detecting device to determine the characteristic of the wireless network signal communicated in the indoor space. The characteristic may include a received signal strength indication (RSSI) of the wireless network signal communicated from a wireless networking device. The mapper may be located at the different points within the indoor space and may provide data points to be analyzed for approximately determining a dimension and thickness of the interior wall. The data points may relate to the RSSI of the wireless network signal located within the indoor space respective to the interior wall to determine a loss factor. The location of the wall may be determined by analyzing the loss factor at the different points about the wall with respect to the RSSI detected at each of the different points. The thickness may be approximated by analyzing attenuation of the wireless network signal caused by the interior wall. In most cases, walls are the biggest factor on indoor WLAN signal loss due mainly to factors such as wall construction material, thickness, and position. The mapper may also determine attenuation of a wireless signal from floors, static objects, moving objects, and other sources of interference.

Location of the wall may be at least partially detected using the network detecting device by analyzing a distance of the mapper from the wireless networking device. The network detecting device may also be used to detect the loss factor experienced by the mapper to the wireless network signal communicated with the wireless networking device. Additionally, the network detecting device may be used to determine a trajectory of the wireless network signal communicated with the mapper. The wireless networking device, and the signal communicated with the wireless networking device, may be determined via triangulation using the wireless network signal detected by the mapper

The RSSI may be analyzed to estimate signal fading caused by the interior wall. The system may analyze the signal fading. In an indoor space having a plurality of wireless networking devices, a client station located in the indoor space may be configurable to connect to the wireless networking device with low incidence of the signal fading. A wireless networking device with a direct line of sight to the client station may have a lowest incidence of signal fading, and may be preferred for connection by the client station.

The mapper may include additional sensors and detection devices to determine one or more condition of an environment, such as the indoor space. For example, the mapper may include sensors to detect climate information, light information, air pressure, magnetic field, sounds, images, and other sensory information that would be apparent to a skilled artisan. Additional sensors includable by the mapper would be apparent to a person of skill in the art after having the benefit of this disclosure.

The map may be associable with a profile storable on a database accessible over a network. The profile may include information relating to the map of the indoor space, the wireless network signals communicated within the indoor space, wireless networking devices operated in the indoor space, and other details relating to the indoor space. The profile may be associable with one or more maps, which may include information relating to one or more indoor space. The profile may also be associable with a movable object is detectable within the indoor space. The moveable object may be detected by analyzing an interference with the wireless network signal for a temporary duration, which may be defined in the profile.

According to an embodiment of the present invention, the system may include an interface. The map may be viewable via the interface. In some embodiments, the map may be viewable in approximately real-time. For example, the mappers may transmit data points detected from within the indoor space to the system, which may analyze the data points to generate the map. This map may be viewed on the display approximately as it is generated.

The map may also include tagged points of interest in the indoor space definable by a user. Additionally, a neighboring wireless signal may be detectable by the mapper and/or the wireless networking device. The wireless networking device may adapt the wireless network signal respective to the neighboring wireless signal. Examples of adapting the wireless network signal may include modifying a communication frequency, amplitude, originating wireless networking device, or another modification that would be apparent to a skilled artisan.

In operation, the indoor mapping system may detect conditions within an indoor space and substantially automatically generate a map of an indoor space. Referring now to FIG. 1, an illustrative diagram of an indoor space is provided. The diagram is being provided as an example to clearly discuss various aspects of the present invention, and is not intended to limit the present invention in any way. Understanding a geography of an indoor space assists with accurately estimating locations and distances of elements in the indoor space. The elements may include walls, which may be a primary signal obstructing object.

As discussed above, the walls may include border walls 12, 14, 16, 18 that encircle a perimeter of the indoor space and interior walls 22, 24, 26 that are located within the indoor space 10. Interior walls may have differing thickness, material, and shape. For example, as illustrated in FIG. 1, interior walls 22 and 24 have different thickness and/or material.

A location within the indoor space 10 may have at least three border walls. Each room may have at least two extra interior walls. Some inner rooms may have four interior walls without sharing any walls with the border walls. For example, inner wall 26 may be approximately perpendicular to inner wall 24 and inner wall 22. Inner wall 24 and inner wall 26 may be approximately parallel to each other.

In the interest of clarity, border walls 12, 14, 16, 18 of FIG. 1 are oriented with respect to compass directions (east, west, south, and north) and include labels to illustrate the same. A mapper 30 may be placed with its back approximately 90 degrees to interior wall 22, pointing in an approximately east direction. The mapper 30 may report its location, direction, and detected wireless network signals. While the mapper 30 is scanning the indoor space 10, the system may draw the wall to connect the scanning points. By using the mapper 30, the system may detect that interior wall 24 and interior wall 22 are parallel and determine that both walls 22, 24 include surfaces facing east and west. To label the indoor space 10 properly, each of the border walls may be labeled (border wall 12, border wall 14, border wall 16, and border wall 18). Border walls will virtually always face to inward to the indoor space. In the context of the indoor space 10 illustrated by FIG. 1, border wall 12 faces east and lines a western border of the indoor space, which is approximately parallel to border wall 16, which faces west and lines the eastern border of the indoor space. Border walls 14 and 18 are approximately parallel to one another and approximately perpendicular to border walls 12 and 16, lining south and north borders of the indoor space, respectively.

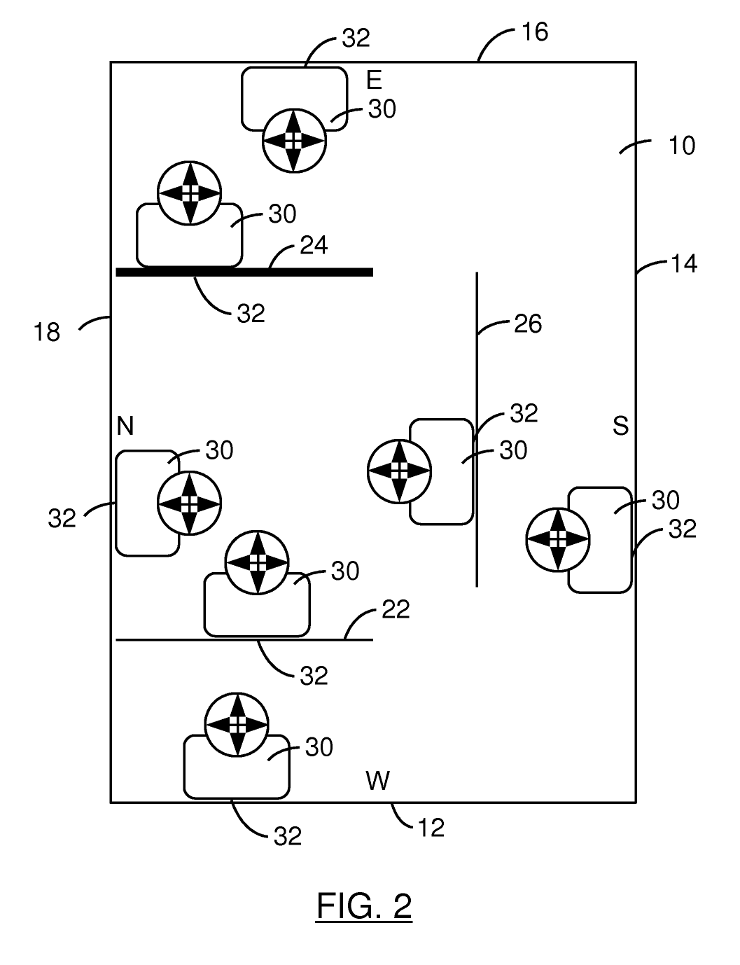

Referring additionally to FIG. 2, an illustrative indoor space 10 with multiple mapper positions will now be discussed. The indoor space 10 of FIG. 2 shows seven positions for the mapper 30. These seven positions are illustrated in the interest of clarity, and are not intended to limit the number of positions and/or mappers 30 usable in an indoor space 10. Each of the border walls 12, 14, 16, 18 may have an adjacent mapper reading facing inside. These mappers 30 may be associated with a profile. The terms “profile” and “profile id” may be used throughout this disclosure interchangeably, without limitation. For example, the data points detected from each mapper point 32 may be associated with a single profile. Skilled artisans will appreciate additional embodiments wherein one or more profiles are associable with the mappers 30 and/or mapper points 32.

The profile may indicate that data points detected and/or recorded by associated mappers 30 relate to a same indoor space 10. Data points or readings detected by the mappers 30 located about the border walls 12, 14, 16, 18 may indicate a border of the indoor space 10. Typically, the border walls 12, 14, 16, 18 will facing inwardly into the interior space 10.

In the interest of clarity, FIG. 2 illustrates an indoor space 10 having a rectangular shape, where the border walls 12, 14, 16, 18 are facing the four main directions of north, south, east, and west. To detect and analyze data points, or take readings, one or more mappers 30 may be located at the mapper points 32 illustrated in FIG. 2. In one embodiment, a mapper 30 may be located at each of the mapper points 32 to take readings. In an alternative embodiment, one or more mappers 30 may be moved to various mapper points 32, taking readings at each mapper point 32. Skilled artisans will appreciate that the mapper points 32 of FIG. 2 are provided to clearly illustrate possible mapper points 32, and that mappers 30 may be positioned at mapper points other than those illustrated in FIG. 2 to take readings without limitation.

A reading taken by a mapper 30 located adjacent to interior wall 22 may indicate data points that show the interior wall 22 is located approximately parallel to border wall 12 and approximately orthogonally to border wall 18. Additionally, readings taken from interior wall 22 and interior wall 24 may indicate that they are approximately parallel one another and approximately orthogonal to border wall 18. Moreover, readings taken from interior wall 26 may indicate that interior wall 26 is approximately parallel to border wall 14. Interior walls 22, 24, and 26 may indicate opposite directions, depending on the face of the wall having the mapper 30 adjacently located and the orientation of the mapper 30, which may be detected and adjusted by the system to correctly locate the walls. For example, a mapper 30 may be located about a west-facing surface of interior wall 22. The compass of the mapper 30 may detect that it is facing west and adapt the readings taken by the mapper 30 accordingly. Such adjustments may be made to the data point detected by the mapper 30 at virtually any mapper point 32 at which a reading may be taken.

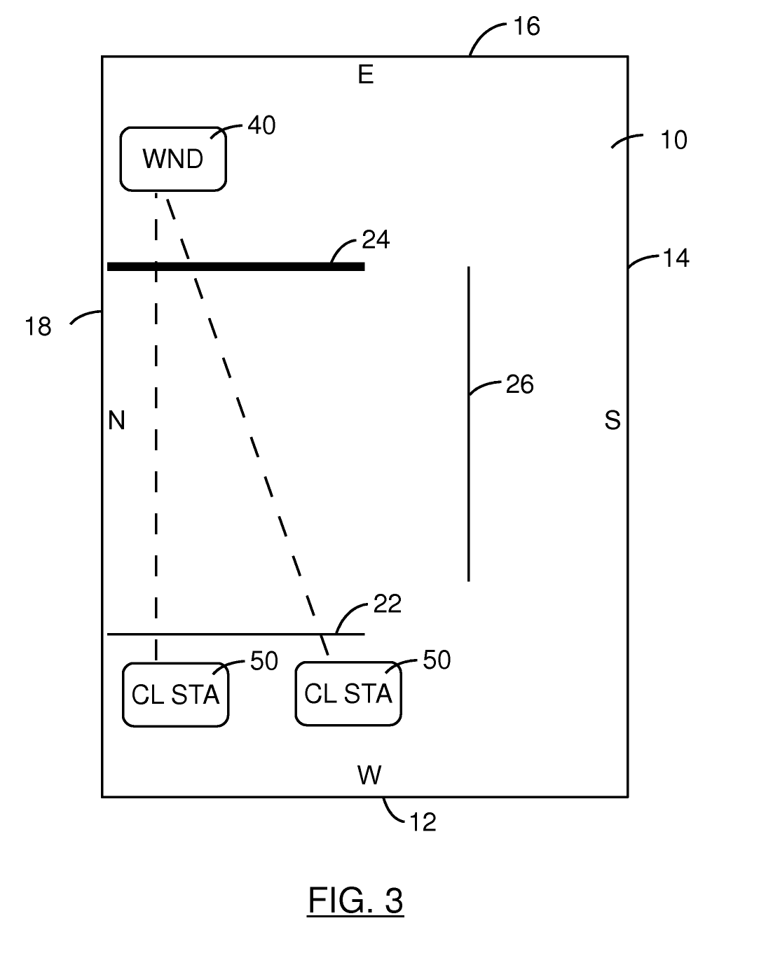

Referring now to FIG. 3, an indoor space 10 with a wireless networking device 40 will be discussed in greater detail. The indoor space 10 of FIG. 3 shows mapper readings for one or more wireless networking device 40 positioned in the indoor space 10 at different locations. Upon determining a location of the wireless networking device 40 with confidence, loss factors relating to interior walls 22 and 24 may be estimated. For example, interior walls 22 and 24 may have approximately the same loss factors. A client station 50, such as a computer, smartphone, or other client device, may commonly be located in the indoor space 10 for communicating with wireless networking device 40. To estimate a distance between the client station 50 and the wireless networking device 40, the system may consider a loss factors caused by interior walls 22 and 24, and a distance between wireless networking device 40 and client station 50. The system may determine the distance using various calculation scenarios. The system may also consider loss caused by floors, static objects, moving objects, and other sources of interference.

For example, in a first scenario, the system may determine a client station distance without considering the wall loss factors. When calculating the distance between a wireless networking device 40 and a client station 50, the system may consider only distance. This distance may be calculated primarily by analyzing the RSSI. However, such a distance may lack accuracy because the RSSI is directly proportional to signal in free space and without any losses. For this reason, many presently existing systems avoid estimating distances.

In a second scenario, the system may also consider the loss factors by analyzing distance and wall loss factors, but without considering trajectory. Here, the loss factors may be considered to calculate the distance. By considering the loss factor and the RSSI, a distance may be calculated accurately, but the location of the client station 50 from the wireless networking device 40 may be at one of multiple locations about a circumference of a circle with a radius equaling the adjusted distance.

Additionally, in a third scenario, the system may advantageously consider the loss factors by analyzing distance, wall loss factors, and trajectory. Here, the system may take multiple reading of one or more wireless networking devices 40 and client stations 50 positioned within the indoor space 10 to reduce an ambiguity of a location for the client station 50 on the circle and increase the precision of locating the device within the indoor space 10. This tracking technique may also be capable of detecting non-stationary objects, including humans, which may interfere with the communicating signal for a temporary duration.

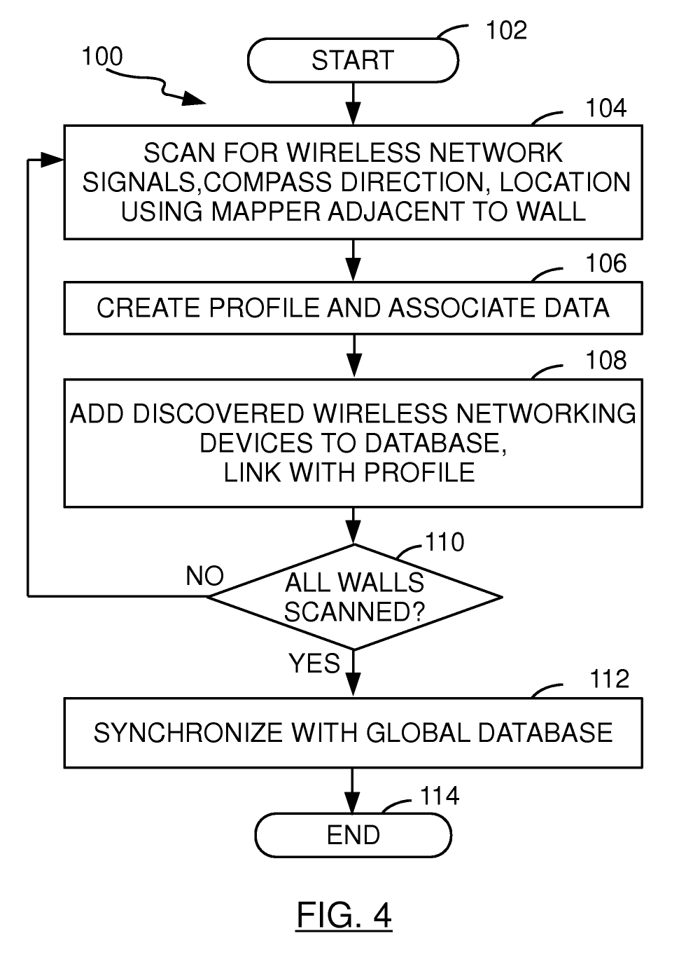

Referring now to flowchart 100 of FIG. 4, an illustrative operation for mapping an indoor space will now be discussed. Starting at Block 102, the system may operate a mapper to scan for wireless networking devices, compass position, GPS location, and/or other data. (Block 104). A profile may be created as a record in a local and/or remote database. The profile may include details relating to the indoor space, GPS longitude and latitude, and compass position, without limitation. (Block 106). Wireless networking devices within a geographic range may be scanned and recorded with the profile in a different database table and indexed with the profile record previously created. (Block 108). Each profile record may include includes a unique profile id, which may be used to link the profile record with the collected wireless networking devices during a particular scan.

The system may determine at Block 110 whether any walls remain to be scanned by a mapper. If it is determined at Block 110 that walls remain to be scanned, the operation may return to Block 104 and repeat the scanning process for all remaining walls to be included in the map. If it is determined at Block 110 that all walls have been scanned, the system may proceed to synchronize the data points resulting from the scans with a global database. (Block 112). In this operation, the border walls may be included in the scan from inside. The internal wall scans may be scanned at least once. To improve the systems results, internal walls may be scanned from both sides. Additionally, each side of a wall may be scanned multiple times. The lines between the scans to display walls can be sketched by a user at the time of the scan and/or automatically generated by the system. The operation may then terminate at Block 114.

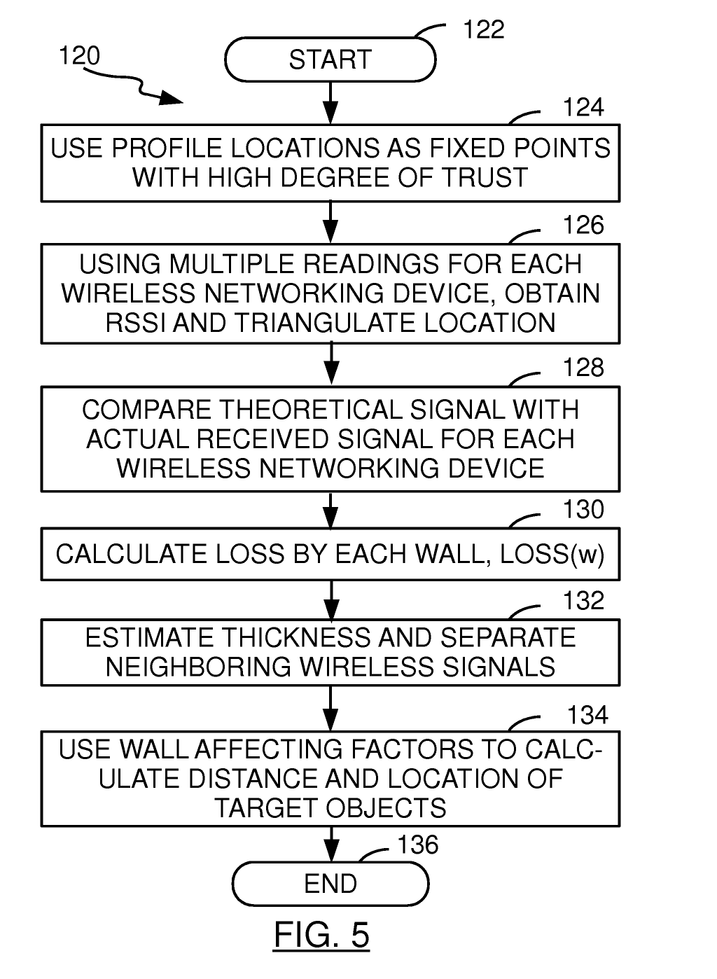

Referring to flowchart 120 of FIG. 5, an illustrative analysis of a wireless network signal in an indoor space will now be discussed. Starting at Block 122, the system may note locations indicated in the profile having a high degree of trust. (Block 124). For example, a profile record may be created with high probability of accurate location of the scanning point, which may be noted by the system. The system may then use multiple readings from a wireless networking device to triangulate a location, for example by using the RSSI. (Block 126). Here, the wireless networking devices may be scanned multiple times using different scanning points or mapper points. Typically, a wireless networking device can be located using three or more scans. With more scans or readings gathered by the mappers, the location of the wireless networking device can be determined with greater confidence.

The system may then compare the theoretical wireless network signal with the actual wireless network signal received for each wireless networking device. (Block 128). Scans having free space between the mapper and the wireless networking device are given higher priority. Free space scans are scans that have direct visibility between the mapper and the scanned wireless networking device. At Block 130, the scans from behind walls are used to estimate the loss factor of each wall, which may be indicated in the profile as LOSS (w). To calculate the loss factor, the system may compare a known device wireless maximum transceiver power to a calculation formula. In this formula, since the maximum power is known and the maximum signal is theoretically known, the values can be compared with the actual received signal. From the amount of loss, the system can estimate the thickness and material of the wall. (Block 132). The system may use these data points and calculations to construct the map of walls, determine the thickness of each wall, and determine locations of the one or more wireless networking devices. The system may detect interferences with the wireless network signals and/or the wall affecting factors to determine a location and distance of additional target objects. (Block 134). A continual location of one or more moving objects may be determined by detecting an interference with the wireless network signal for a temporary duration. The operation may then terminate at Block 136. Skilled artisans will appreciate that the system may additionally measure wireless signal loss may be caused by additional walls, floors, static objects, moving objects, and other sources of interference.

To make the user experience better with regard to creating an indoor map, users can sketch their interior walls between the scanned points and tag the points of interest (rooms, windows, doors, etc. . . . ) using an interface. For example, the interface may be accessible via a mobile device application. In another example, the interface may be manipulated by touching a screen of the interface to indicate the borders walls of the building, interior walls, and/or other points of interest to be tagged.

An illustrative method of operating the system of the present invention will now be discussed without limitation. More specifically, according to an embodiment of the present invention, a method of mapping an indoor space will now be discussed. The method may include positioning a mapper at a point within the indoor space to determine boundaries for a map. Here, a characteristic of a wireless network signal communicable in the indoor space may also be determined. The map may define the indoor space to include an area substantially defined by one or more walls. For example, the indoor space may include an area substantially surrounded by border walls.

Determining the boundaries for the map may be achieved by operating a mapper, which has been discussed in detail above. To determine the boundaries of the interior space, a compass of the mapper may be operated to identify an orientation of the border walls. Additionally, a location detecting device of the mapper may be operated to determine a location of the walls, floors, ceilings, and objects. An elevation detecting device may also be operated to determine an elevation of the indoor space and/or wall. Furthermore, determining the additional aspects for the map may include operating a network detecting device to determine the characteristic of the wireless network signal communicated in the indoor space. The characteristic determined by the network detecting device may include a received signal strength indication (RSSI) of the wireless network signal communicated from a wireless networking device.

The operation may also include substantially automatically determining the map by orienting the mapper at different points within the indoor space. The system may associate the map with a profile storable on a database, which may be accessible over a network. The wireless network signal may also be associable with the profile. The system may also detect a movable object within the indoor space by analyzing an interference with the wireless network signal for a temporary duration. For example, as a moveable object becomes positioned between a wireless networking device and a mapper, the signal may be at least partially attenuated by the object. The mapper may sense this attenuation to detect the presence of the moveable object. The movable object may be defined in the profile.

The mapper may be moved about the wall to determine a shape of the wall. In an additional embodiment, a plurality of mappers may be included in the indoor space to analyze and map the indoor space.

The map may be indicative of the elevation. For example, the map may be indicative of an elevation of the indoor space being analyzed, such as to determine a floor of the building at which the indoor space is located. Alternatively, the map may indicate an elevation of a wall and/or wireless networking device detected within the indoor space. A wireless network signal detected by the system may be associated with the profile.

As discussed above, the wall may refer to one or more border wall and one or more interior wall. The border wall may substantially enclose the indoor space. The mapper may detect the border wall to define at least part of the indoor space. One or more interior wall may be located substantially within the indoor space, which may also include one or more mapper located at the different points within the indoor space. The mappers may provide data points relating to the interior wall, which can be analyzed for approximately determining a dimension and thickness of the interior wall. The data points may relate to the RSSI of the wireless network signal located within the indoor space respective to the interior wall. These data points may be analyzed to determine the loss factor, which may be further analyzed at the different points about the wall, with respect to the RSSI detected at each of the different points, to determine the location of the wall.

The operation may additionally include analyzing a distance of the mapper from the wireless networking device, the loss factor experienced by the mapper to the wireless network signal communicated with the wireless networking device, and a trajectory of the wireless network signal communicated with the mapper. Attenuation of the wireless network signal caused by the interior wall may be analyzed to approximate the thickness of the interior wall. Additionally, the RSSI may be analyzed to estimate signal fading caused by the interior wall. A client station may be configurable to connect to a wireless networking device with low incidence of the signal fading. Also, RSSI may be analyzed to estimate signal fading caused by floors, static objects, moving objects, and other sources of interference.

In an embodiment of the operation, the map may be viewable via an interface. The map may be updated and viewable via the interface in approximately real-time. The location detecting device may include a GPS sensor and/or an accelerometer. The GPS sensor may detect the position of the mapper via GPS satellite positioning, which will be understood by skilled artisans. Additionally, the accelerometer may be operated as a mapper is moved about a wall and/or interior space to determine a distance or length of the quantity being measured. For example, a mapper may be positioned at the edge of an interior wall. The mapper may determine a position using the GPS sensor. The mapper may then be moved across the length of the wall. The accelerometer may measure the distance moved along the horizontal axis to determine a length of the wall. In addition, a position of the mapper at the second end of the wall may be detected using the GPS sensor. The measurements may be compared to determine a level of confidence for the dimension of the wall calculated. In an additional scenario, the mapper may be walked across an indoor space to assist in measuring an area included by the interior space.

The wireless networking device may be locatable via triangulation using the wireless network signal detected by the mapper at various mapper points. Distance may also be calculated using triangulation or another metric capable of analyzing the wireless network signal. To calculate a distance using the signal strength, frequency of the wireless network signal being used by the wireless networking device may be considered. A neighboring wireless signal is detectable in the indoor space, for which the system may adapt the wireless network signal respective to the neighboring wireless signal.

As mentioned above, the system may include tagged points of interest in the indoor space definable by a user. The system may also detect movable objects. Movable objects may include semi-stationary objects such as furniture or people. For tracking indoor moving objects, an indoor map can be used as a reference for the different object locations.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. An indoor mapping system comprising:
a map of an indoor space comprising an area substantially defined by a wall; and
a mapper positionable at a point within the indoor space to determine boundaries for the map and a characteristic of a wireless network signal communicable in the indoor space, the mapper further comprising:
a compass to identify an orientation of the wall,
a location detecting device to determine a location of the wall,
an elevation detecting device to determine an elevation, and
a network detecting device to determine the characteristic of the wireless network signal communicated in the indoor space, the characteristic comprising a received signal strength indication (RSSI) of the wireless network signal communicated from a wireless networking device;
wherein the map is substantially automatically determined by the mapper being oriented at different points within the indoor space;
wherein the mapper is movable about the wall to determine a shape of the wall;
wherein the map is indicative of the elevation;
wherein the map is associable with a profile storable on a database accessible over a network;
wherein the wireless network signal is associable with the profile;
wherein a movable object is detectable within the indoor space by analyzing an interference with the wireless network signal for a temporary duration, the movable object being definable in the profile.

2. The system of claim 1, wherein the wall comprises a border wall and an interior wall, the border wall substantially enclosing the indoor space and being detectable by the mapper to define at least part of the indoor space, the interior wall being located substantially within the indoor space, wherein the mapper being located at the different points within the indoor space provides data points relating to the interior wall to be analyzed for approximately determining a dimension and thickness of the interior wall, and wherein the data points relate to the RSSI of the wireless network signal located within the indoor space respective to the interior wall to determine a loss factor.

3. The system of claim 2, wherein the location of the wall is determinable by analyzing the loss factor at the different points about the wall with respect to the RSSI detected at each of the different points.

4. The system of claim 3, wherein determining the location of the wall comprises analyzing a distance of the mapper from the wireless networking device, the loss factor experienced by the mapper to the wireless network signal communicated with the wireless networking device, and a trajectory of the wireless network signal communicated with the mapper.

5. The system of claim 2, wherein the thickness is approximated by analyzing attenuation of the wireless network signal caused by the interior wall.

6. The system of claim 2, wherein the RSSI is analyzed to estimate signal fading caused by the interior wall, and wherein a client station is configurable to connect to the wireless networking device with low incidence of the signal fading.

7. The system of claim 1, further comprising an interface, the map being viewable via the interface.

8. The system of claim 7, wherein the map is viewable via the interface in approximately real-time

9. The system of claim 1, wherein the location detecting device comprises a GPS sensor.

10. The system of claim 1, wherein the location detecting device comprises an accelerometer.

11. The system of claim 1, wherein the wireless networking device is locatable via triangulation using the wireless network signal detected by the mapper.

12. The system of claim 1, wherein the map further comprises tagged points of interest in the indoor space definable by a user.

13. The system of claim 1, wherein a neighboring wireless signal is detectable and the wireless network signal is adaptable respective to the neighboring wireless signal.

14. An indoor mapping system comprising:
a map of an indoor space comprising an area substantially defined by a wall, wherein the wall further comprises:
a border wall substantially enclosing the indoor space, and
an interior wall being located substantially within the indoor space; and
a mapper positionable at a point within the indoor space to determine boundaries for the map and a characteristic of a wireless network signal communicable in the indoor space, the mapper further comprising:
a location detecting device to determine a location of the wall, and
a network detecting device to determine the characteristic of the wireless network signal communicated in the indoor space, the characteristic comprising a received signal strength indication (RSSI) of the wireless network signal communicated from a wireless networking device;
wherein the border wall is detectable by the mapper to define at least part of the indoor space;
wherein the map is substantially automatically determined by the mapper being oriented at different points within the indoor space;
wherein the mapper is movable about the wall to determine a shape of the wall;
wherein the mapper being located at the different points within the indoor space provides data points relating to the interior wall to be analyzed for approximately determining a dimension and thickness of the interior wall, the data points relating to the RSSI of the wireless network signal located within the indoor space respective to the interior wall to determine a loss factor;
wherein the map is associable with a profile storable on a database accessible over a network;
wherein the wireless network signal is associable with the profile;
wherein a movable object is detectable within the indoor space by analyzing an interference with the wireless network signal for a temporary duration, the moveable object being definable in the profile.

15. The system of claim 14, wherein the mapper further comprise a compass to identify an orientation of the wall.

16. The system of claim 14, wherein the mapper comprises an elevation detection device to determine an elevation, and wherein the map is indicative of the elevation.

17. The system of claim 14, wherein the thickness is approximated by analyzing attenuation of the wireless network signal caused by the interior wall.

18. The system of claim 14, wherein the RSSI is analyzed to estimate signal fading caused by the interior wall, and wherein a client station is configurable to connect to the wireless networking device with low incidence of the signal fading.

19. The system of claim 14, further comprising an interface, the map being viewable via the interface.

20. The system of claim 19, wherein the map is viewable via the interface in approximately real-time.

21. The system of claim 14, wherein the location detecting device comprises a GPS sensor.

22. The system of claim 14, wherein the location detecting device comprises an accelerometer.

23. The system of claim 14, wherein the wireless networking device is locatable via triangulation using the wireless network signal detected by the mapper.

24. The system of claim 14, wherein the map further comprises tagged points of interest in the indoor space definable by a user.

25. The system of claim 14, wherein a neighboring wireless signal is detectable and the wireless network signal is adaptable respective to the neighboring wireless signal.

26. A method of mapping an indoor space comprising:
(a) positioning a mapper at a point within the indoor space to determine boundaries for a map and a characteristic of a wireless network signal communicable in the indoor space, the map defining the indoor space comprising an area substantially defined by a wall, determining the boundaries further comprising:
(i) operating a compass of the mapper to identify an orientation of the wall,
(ii) operating a location detecting device of the mapper to determine a location of the wall,
(iii) operating an elevation detecting device to determine an elevation of the wall, and
(iv) operating a network detecting device to determine the characteristic of the wireless network signal communicated in the indoor space, the characteristic comprising a received signal strength indication (RSSI) of the wireless network signal communicated from a wireless networking device;
(b) determining the map substantially automatically by the mapper being oriented at different points within the indoor space;
(c) associating the map with a profile storable on a database accessible over a network, the wireless network signal being associable with the profile; and
(d) detecting a movable object within the indoor space by analyzing an interference with the wireless network signal for a temporary duration, the movable object being definable in the profile;
wherein the mapper is movable about the wall to determine a shape of the wall;
wherein the map is indicative of the elevation;
wherein the wireless network signal is associable with the profile.

27. The method of claim 26, wherein the wall comprises a border wall and an interior wall, the border wall substantially enclosing the indoor space and being detectable by the mapper to define at least part of the indoor space, the interior wall being located substantially within the indoor space, wherein the mapper being located at the different points within the indoor space provides data points relating to the interior wall to be analyzed for approximately determining a dimension and thickness of the interior wall, and wherein the data points relate to the RSSI of the wireless network signal located within the indoor space respective to the interior wall to determine a loss factor.

28. The system of claim 27, further comprising:
(e) analyzing the loss factor at the different points about the wall with respect to the RSSI detected at each of the different points to determine the location of the wall.

29. The system of claim 28, wherein step (e) further comprises analyzing a distance of the mapper from the wireless networking device, the loss factor experienced by the mapper to the wireless network signal communicated with the wireless networking device, and a trajectory of the wireless network signal communicated with the mapper.

30. The system of claim 27, further comprising:
(f) analyzing attenuation of the wireless network signal caused by the interior wall to approximate the thickness of the interior wall.

31. The system of claim 27, further comprising:
(g) analyzing the RSSI to estimate signal fading caused by the interior wall, wherein a client station is configurable to connect to the wireless networking device with low incidence of the signal fading.

32. The system of claim 26, wherein the map is viewable via an interface.

33. The system of claim 32, wherein the map is viewable via the interface in approximately real-time.

34. The system of claim 26, wherein the location detecting device comprises a GPS sensor.

35. The system of claim 26, wherein the location detecting device comprises an accelerometer.

36. The system of claim 26, wherein the wireless networking device is locatable via triangulation using the wireless network signal detected by the mapper.

37. The system of claim 26, wherein the map further comprises tagged points of interest in the indoor space definable by a user.

38. The system of claim 26, wherein a neighboring wireless signal is detectable, the method further comprising:
(h) adapting the wireless network signal respective to the neighboring wireless signal.
